(19) United States
(12) Patent Application Publication
(10) Pub. No.: US 2024/0157539 A1
(43) Pub. Date: May 16, 2024

(54) HANDLE, HAIR DRYER, FACIAL CARE DEVICE, AND HAIR IRON

(71) Applicant: Murata Manufacturing Co., Ltd., Kyoto (JP)

(72) Inventors: Shinji OKAWA, Kyoto (JP); Koji OSAKI, Kyoto (JP)

(21) Appl. No.: 18/422,684

(22) Filed: Jan. 25, 2024

Related U.S. Application Data
(63) Continuation of application No. PCT/JP2022/028682, filed on Jul. 26, 2022.

(30) Foreign Application Priority Data
Jul. 27, 2021 (JP) 2021-122438

(51) Int. Cl. B25G 1/00; A45D 1/04; A45D 1/28; A45D 2/40; A45D 20/12

(52) U.S. Cl. CPC B25G 1/00; A45D 1/04; A45D 1/28; A45D 2/40; A45D 20/12

(57) ABSTRACT

A handle includes a housing that includes a first vibrating body and a second vibrating body. A control device is able to generate a first force sensation in a first direction by controlling a vibration pattern of the first vibrating body and to generate a second force sensation in a second direction by controlling a vibration pattern of the second vibrating body. The control device is able to control so as to set the first direction and the second direction are the same. The control device is able to control the vibration pattern of the first vibrating body and the vibration pattern of the second vibrating body so as not to allow a virtual line directed from the first vibrating body in the first direction and a virtual line directed from the second vibrating body in the second direction to be positioned on a single line.

### CROSS REFERENCE TO RELATED APPLICATION

This is a continuation of International Application No. PCT/JP2022/028682 filed on Jul. 26, 2022 which claims priority from Japanese Patent Application No. 2021-122438 filed on Jul. 27, 2021. The contents of these applications are incorporated herein by reference in their entireties.

### BACKGROUND ART

### Technical Field

The present disclosure relates to a handle, a hair dryer, a facial care device, and a hair iron.

In Patent Document 1, a hair dryer is described. This hair dryer includes a handle having a columnar housing and a head that is connected to the housing and that can blow air. When the hair dryer is used, the handle is held by the user with his or her hand, and the head is moved while being directed to the user's hair.
Patent Document 1: Japanese Unexamined Patent Application Publication No. 2018-175726

### BRIEF SUMMARY

With the hair dryer as described in Patent Document 1, in order to efficiently dry hair or avoid damage to the hair, there should be an ideal way of moving the hair dryer. However, the hair dryer cannot suggest to the user how to move the hair dryer, and the way of moving the hair dryer has to be left to the user's discretion. This problem is not limited to the hair dryer. A similar problem arises with a device a handle of which is held by the user to use the device such as a facial care device or a hair iron.

To address the above-described problems, a handle according to an aspect of the present disclosure includes a housing that a user is able to hold with his or her fingers, a first vibrating body disposed in the housing, a second vibrating body disposed in the housing, and a control device able to generate a first force sensation in a first direction by controlling a vibration pattern of the first vibrating body and able to generate a second force sensation in a second direction by controlling a vibration pattern of the second vibrating body. The control device is able to control the vibration pattern of the first vibrating body and the vibration pattern of the second vibrating body so as to set the first direction and the second direction to be identical to each other, and so as not to allow a virtual line directed from the first vibrating body in the first direction and a virtual line directed from the second vibrating body in the second direction to be positioned on a single line.

According to the above-described configuration, a force sensation with which the user feels as if the handle were translated in the first direction can be given to the user who holds the housing of the handle. Accordingly, the user can be notified of a situation in which the handle is to be translated.

Meanwhile, when only one vibrating body is used, a force sensation with which the user feels as if the handle were rotated may be given to the user depending on the position of the housing held by the user. With the above-described configuration, the vibration patterns can be controlled so that the first direction and the second direction are in the same direction. In this case, there is a low possibility of giving the force sensation with which the user feels as if the handle were rotated, and the user can be notified of a situation in which the handle is to be translated.

To address the above-described problems, a hair dryer according to another aspect of the present disclosure includes a handle including a first vibrating body and a second vibrating body, a head that is connected to the handle and that is configured to blow air, a temperature sensor configured to detect a temperature of an object at a destination of the blown air, and a control device able to generate a first force sensation in a first direction by controlling a vibration pattern of the first vibrating body and able to generate a second force sensation in a second direction by controlling a vibration pattern of the second vibrating body. The control device is able to execute a first control that controls the vibration pattern of the first vibrating body and the vibration pattern of the second vibrating body so as to set the first direction and the second direction to be identical to each other, and so as not to allow a virtual line directed from the first vibrating body in the first direction and a virtual line directed from the second vibrating body in the second direction to be positioned on a single line. The control device executes the first control depending on the temperature.

According to the above-described configuration, depending on the temperature, the control device executes the first control. Accordingly, depending on the temperature, the user can be given a force sensation with which the user feels as if the handle were translated in the first direction. Thus, depending on the temperature, the user can be notified of a situation in which translation is to be performed.

To address the above-described problems, a facial care device according to yet another aspect of the present disclosure includes a handle including a first vibrating body and a second vibrating body, a head that is connected to the handle and that includes an output portion for performing skin care, a pressure sensor configured to detects a pressure of the head, and a control device able to generate a first force sensation in a first direction by controlling a vibration pattern of the first vibrating body and able to generate a second force sensation in a second direction by controlling a vibration pattern of the second vibrating body. The control device is able to execute a first control that controls the vibration pattern of the first vibrating body and the vibration pattern of the second vibrating body so as to set the first direction and the second direction to be identical to each other, and so as not to allow a virtual line directed from the first vibrating body in the first direction and a virtual line directed from the second vibrating body in the second direction to be positioned on a single line. The control device executes the first control depending on the pressure.

According to the above-described configuration, the control device executes the first control depending on the pressure. Accordingly, depending on the pressure, the user can be given a force sensation with which the user feels as if the handle were translated in the first direction. Thus, depending on the pressure, the user can be notified of a situation in which translation is to be performed.

To address the above-described problems, a hair iron according to yet another aspect of the present disclosure includes a handle including a first vibrating body and a second vibrating body, a head that is connected to the handle and that includes a first clamping portion and a second clamping portion for clamping hair, a control device able to generate a first force sensation in a first direction by controlling a vibration pattern of the first vibrating body and able to generate a second force sensation in a second direction by controlling a vibration pattern of the second vibrating body, and a distance sensor configured to detect a distance from an object positioned in an opposite direction to the first direction as viewed from the head. At least one of the first clamping portion and the second clamping portion includes a heater for warming the hair. The control device is able to execute a first control that controls the vibration pattern of the first vibrating body and the vibration pattern of the second vibrating body so as to set the first direction and the second direction to be identical to each other, and so as not to allow a virtual line directed from the first vibrating body in the first direction and a virtual line directed from the second vibrating body in the second direction to be positioned on a single line. The control device executes the first control depending on the distance.

According to the above-described configuration, the control device executes the first control depending on the distance. Accordingly, depending on the distance, the user can be given a force sensation with which the user feels as if the handle were translated in the first direction. Thus, depending on the distance, the user can be notified of a situation in which translation is to be performed.

To address the above-described problems, a hair iron according to yet another aspect of the present disclosure includes a handle including a first vibrating body and a second vibrating body, a head that is connected to the handle and that includes a first clamping portion and a second clamping portion for clamping hair, a control device able to generate a first force sensation in a first direction by controlling a vibration pattern of the first vibrating body and able to generate a second force sensation in a second direction by controlling a vibration pattern of the second vibrating body, and a temperature sensor configured to detect a temperature between the first clamping portion and the second clamping portion. At least one of the first clamping portion and the second clamping portion includes a heater for warming the hair. The control device is able to execute a first control that controls the vibration pattern of the first vibrating body and the vibration pattern of the second vibrating body so as to set the first direction and the second direction to be identical to each other, and so as not to allow a virtual line directed from the first vibrating body in the first direction and a virtual line directed from the second vibrating body in the second direction to be positioned on a single line. The control device executes the first control depending on the temperature.

According to the above-described configuration, depending on the temperature, the control device executes the first control. Accordingly, depending on the temperature, the user can be given a force sensation with which the user feels as if the handle were translated in the first direction. Thus, depending on the temperature, the user can be notified of a situation in which translation is to be performed.

To address the above-described problems, a hair iron according to yet another aspect of the present disclosure includes a handle including a first vibrating body and a second vibrating body, a head that is connected to the handle and that includes a first clamping portion and a second clamping portion for clamping hair, a control device able to generate a first force sensation in a first direction by controlling a vibration pattern of the first vibrating body and able to generate a second force sensation in a second direction by controlling a vibration pattern of the second vibrating body, and an open/close sensor configured to detect an open/close state of the first clamping portion and the second clamping portion. At least one of the first clamping portion and the second clamping portion includes a heater for warming the hair. The control device is able to execute a first control that controls the vibration pattern of the first vibrating body and the vibration pattern of the second vibrating body so as to set the first direction and the second direction to be identical to each other, and so as not to allow a virtual line directed from the first vibrating body in the first direction and a virtual line directed from the second vibrating body in the second direction to be positioned on a single line. The control device executes the first control when a predetermined specified period of time has elapsed from a time when the open/close state became a closed state.

According to the above-described configuration, the control device executes the first control when the specified period of time has elapsed from closing of the first clamping portion and the second clamping portion. Thus, when a specified period of time has elapsed from the start of clamping of hair, the user is notified of a situation in which translation is to be performed.

To address the above-described problems, a handle according to yet another aspect of the present disclosure includes a housing that a user is able to hold with his or her fingers, a haptics unit that is disposed in the housing and that includes a first vibrating body and a second vibrating body, and a control unit configured to control the haptics unit. The control unit is able to control the haptics unit so as to cause the haptics unit to give the user who holds the housing a force sensation with which the user feels as if the housing were translated.

According to the above-described configuration, a force sensation with which the user feels as if the housing were translated can be given to the user who holds the housing of the handle. Thus, the user can be notified of a situation in which the handle is to be translated.

The user can be suggested how to move the handle.

### BRIEF DESCRIPTION OF THE DRAWINGS

FIG. 1 is an overall view illustrating a hair dryer according to a first embodiment.

FIG. 2 is an explanatory view illustrating a usage state of the hair dryer according to the first embodiment.

FIG. 3 is an overall view illustrating a facial care device according to a second embodiment.

FIG. 4 is an explanatory view illustrating a usage state of the facial care device according to the second embodiment.

FIG. 5 is an explanatory view illustrating the usage state of the facial care device according to the second embodiment.

FIG. 6 is an overall view illustrating a hair iron according to a third embodiment.

FIG. 7 is an explanatory view illustrating a usage state of the hair iron according to the third embodiment.

FIG. 8 is an overall view illustrating a hair iron according to a fourth embodiment.

FIG. 9 is an explanatory view illustrating a usage state of the hair iron according to the fourth embodiment.

FIG. 10 is an overall view illustrating a hair iron according to a fifth embodiment.

### DETAILED DESCRIPTION

### First Embodiment

Hereinafter, a first embodiment in which a handle is applied to a hair dryer is described with reference to the drawings. In the drawings, elements may be illustrated in enlarged scale to facilitate the understanding. The rates of the dimensions of the elements may be different from the actual rates or the rates in other drawings.

(About Overall Configuration)

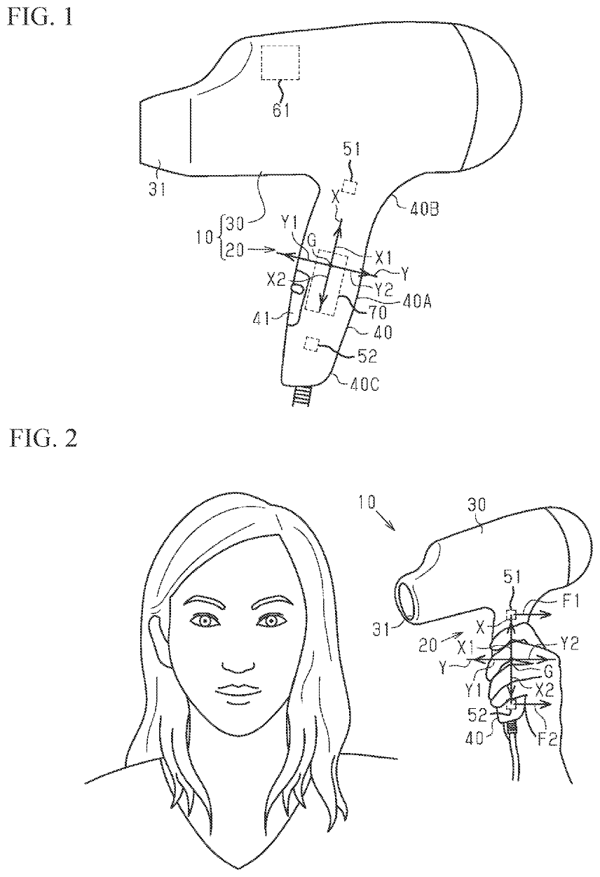

As illustrated in FIG. 1, a hair dryer 10 includes a handle 20 and a head 30. The handle 20 includes a housing 40 that the user can hold with his or her fingers. The housing 40 as a whole has a circular column shape.

An axis that passes through a center of gravity G of the housing 40 and extends in a direction in which the housing 40 extends is defined as a first reference axis X. One of axes orthogonal to the first reference axis X is defined as a second reference axis Y. One of directions along the first reference axis X is defined as a first positive direction X1, and a direction opposite to the first positive direction X1 out of the directions along the first reference axis X is defined as a first negative direction X2. One of directions along the second reference axis Y is defined as a second positive direction Y1, and a direction opposite to the second positive direction Y1 out of the directions along the second reference axis Y is defined as a second negative direction Y2.

The dimension of the housing 40 in a direction along the first reference axis X is greater than the dimension of the housing 40 in a direction along the second reference axis Y. Furthermore, the dimension of the housing 40 in the direction along the first reference axis X is greater than the dimension of the housing 40 in a direction along an axis orthogonal to both the first reference axis X and the second reference axis Y. That is, the housing 40 has a shape elongated in the direction along the first reference axis X. A switch 41 to turn on/off the power of the hair dryer 10 is provided in the housing 40.

The housing 40 is broadly divided into a grip portion 40A, a first end portion 40B, and a second end portion 40C. The grip portion 40A is a central portion of the housing 40 including the center of gravity G. More specifically, the grip portion 40A is a portion that can be positioned on the inside of the fingers when the user holds the housing 40 with the fingers. According to the present embodiment, the grip portion 40A is defined as a range of 5 cm in the first positive direction X1 and 5 cm in the first negative direction X2 from the center of gravity G as the center, that is, a range of 10 cm in total. The first end portion 40B is adjacent to an end of the grip portion 40A on a side in the first positive direction X1. The second end portion 40C is adjacent to an end of the grip portion 40A on a side in the first negative direction X2.

The head 30 is connected to an end of the housing 40 on the side in the first positive direction X1, that is, the first end portion 40B. The head 30 as a whole has a cylindrical shape elongated in a direction along the second reference axis Y. The head 30 includes a blower portion 31 that can blow warm air. Although it is not illustrated, the blower portion 31 includes a heating element for heating air and a fan for blowing the air. Heated air is blown outward from a distal end side of the blower portion 31 of the head 30. When hair is exposed to the warm air blown from the head 30, the hair at the destination of the blown air can be dried. It is sufficient that the blower portion 31 be able to blow the air. The air blown by the blower portion 31 is not limited to warm air and may be cool air.

The handle 20 includes a first vibrating body 51 and a second vibrating body 52. The first vibrating body 51 is disposed in the first end portion 40B of the housing 40. The first vibrating body 51 has a substantially cubic shape. Out of outer surfaces of the first vibrating body 51, four outer surfaces respectively face the first positive direction X1, the first negative direction X2, the second positive direction Y1, and the second negative direction Y2.

Although it is not illustrated, the first vibrating body 51 includes voice coil motors corresponding to the respective surfaces, weights corresponding to the respective voice coil motors, and a cube-shaped casing in which the voice coil motors and the weights are housed. The weights vibrate due to forces generated when currents flow through coils of the voice coil motors. When the weights vibrate, the casing vibrates due to the vibration of the weights. Accordingly, the first vibrating body 51 vibrates in each of the directions along the first reference axis X and the directions along the second reference axis Y due to control of the currents flowing through the coils of the voice coil motors. More specifically, the first vibrating body 51 is such a vibrating body described in, for example, Japanese Unexamined Patent Application Publication No. 2005-190465. The first vibrating body 51 is positioned on the first reference axis X. Furthermore, the first vibrating body 51 is positioned on the side in the first positive direction X1 as viewed from the center of gravity G of the housing 40.

The second vibrating body 52 is disposed in the second end portion 40C of the housing 40. The second vibrating body 52 is a vibrating body similar to the first vibrating body 51. The second vibrating body 52 is positioned on the first reference axis X. The second vibrating body 52 is positioned on the side in the first negative direction X2 as viewed from the center of gravity G of the housing 40. The distance between the center of gravity G of the housing 40 and the first vibrating body 51 is set to be equal to the distance between the center of gravity G of the housing 40 and the second vibrating body 52.

The hair dryer 10 includes a temperature sensor 61. The temperature sensor 61 detects the temperature of an object at the destination of the warm air blown from the distal end side of the blower portion 31 of the head 30. For example, the temperature sensor 61 is an infrared temperature sensor and detects the temperature of the object within several tens of cm from the distal end of the blower portion 31 in a contactless manner.

The hair dryer 10 includes a control device 70. The control device 70 includes a central processing unit (CPU) and a read only memory (ROM) to execute software processes. The control device 70 obtains a signal indicating the temperature from the temperature sensor 61. In particular, the control device 70 controls operation of the first vibrating body 51 and operation of the second vibrating body 52.

The control device 70 can generate a force sensation in the first vibrating body 51 by controlling a vibration pattern of the first vibrating body 51. According to the present embodiment, as a direction of the force sensation generated from the first vibrating body 51, any one of the directions can be selected from among the first positive direction X1, the first negative direction X2, the second positive direction Y1, and the second negative direction Y2. Specifically, the control device 70 controls the currents flowing through the voice coil motors of the first vibrating body 51 so as to generate vibration in an amplitude direction which is a direction along the first reference axis X direction or along the second reference axis Y. Furthermore, the control device 70 controls vibration patterns of the vibration in the directions along a single reference axis as described above to generate the force sensation in one direction or the other direction of the reference axis. The force sensation refers to a sensation of a drag received from an object. Accordingly, for example, when a force sensation in the first positive direction X1 is generated in the first vibrating body 51, although the first vibrating body 51 actually performs reciprocation motion at the same position, the user feels as if the first vibrating body 51 were displaced in the first positive direction X1. Hereinafter, a force sensation generated from the first vibrating body 51 is defined as a first force sensation, and the direction of the first force sensation is defined as a first direction F1.

As is the case with the first vibrating body 51, the control device 70 can generate a force sensation in the second vibrating body 52 by controlling a vibration pattern of the second vibrating body 52. Hereinafter, a force sensation generated from the second vibrating body 52 is defined as a second force sensation, and the direction of the second force sensation is defined as a second direction F2.

The control device 70 can execute a first control that sets the first direction F1 of the first force sensation and the second direction F2 of the second force sensation to a specific direction. When the first control is executed, the first direction F1 and the second direction F2 are set in the same direction. Furthermore, when the first control is executed, a virtual line directed from the first vibrating body 51 in the first direction F1 and a virtual line directed from the second vibrating body 52 in the second direction F2 are not positioned on the same line. Specifically, according to the present embodiment, the control device 70 executes the first control with the first direction F1 and the second direction F2 set to the second negative direction Y2.

The control device 70 executes the first control depending on the temperature obtained from the temperature sensor 61. Specifically, the control device 70 executes the first control when the temperature obtained from the temperature sensor 61 exceeds a predetermined specified temperature. The specified temperature is set to, for example, 80° C. After executing the first control, the control device 70 ends the first control when the temperature obtained from the temperature sensor 61 becomes lower than or equal to the specified temperature.

### About Action of First Embodiment

It is assumed that, as illustrated in FIG. 2, the user causes the hair to be exposed to the warm air from the blower portion 31 so as to dry the hair. In this case, when the user causes the same portion of the hair to be continuously exposed to the warm wind, the temperature of the hair increases. According to the above-described first embodiment, the control device 70 executes the first control when the temperature of the portion continuously exposed to the warm wind exceeds the specified temperature.

Accordingly, the first force sensation is generated from the first vibrating body 51 in the first direction F1, that is, the second negative direction Y2. Also, the second force sensation is generated from the second vibrating body 52 in the second direction F2, that is, the second negative direction Y2.

### About Effects of First Embodiment

(1-1) According to the above-described first embodiment, under the first control, the first direction F1 and the second direction F2 are the same direction. Furthermore, under the first control, the control device 70 does not allow the virtual line directed from the first vibrating body 51 in the first direction F1 and the virtual line directed from the second vibrating body 52 in the second direction F2 to be positioned on the same line. To the user who holds the housing 40 of the handle 20, this can give a force sensation with which the user feels as if the handle 20 were moved in the first direction F1.

Meanwhile, it is assumed that only one vibrating body is provided, or although two vibrating bodies are provided, the virtual line directed from the first vibrating body 51 in the first direction F1 and the virtual line directed from the second vibrating body 52 in the second direction F2 are positioned on the same line. In such cases, a force sensation with which the user feels as if the handle 20 were rotated may be given to the user depending on the position of the housing 40 held by the user. In this regard, according to the above-described first embodiment, under the first control, the virtual line directed from the first vibrating body 51 in the first direction F1 and the virtual line directed from the second vibrating body 52 in the second direction F2 are not positioned on the same line. Accordingly, there is a low possibility of giving a force sensation with which the user feels as if the handle 20 were rotated, and the user can be notified of a situation in which the handle 20 is to be translated.

(1-2) According to the above-described first embodiment, the first vibrating body 51 is positioned on the side in the first positive direction X1 as viewed from the center of gravity G of the housing 40. Also, the second vibrating body 52 is positioned on the side in the first negative direction X2 as viewed from the center of gravity G of the housing 40. This facilitates giving a force sensation with which the user feels as if the hand were entirely translated to the hand that holds the housing 40 of the handle 20.

(1-3) According to the above-described first embodiment, the housing 40 includes the grip portion 40A, the first end portion 40B, and the second end portion 40C. The first vibrating body 51 is disposed in the first end portion 40B. The second vibrating body 52 is disposed in the second end portion 40C. Thus, the first vibrating body 51 and the second vibrating body 52 are positioned so as to be considerably separate from each other. Accordingly, the first force sensation and the second force sensation are generated at respective locations far from each other as viewed from the center of gravity G of the housing 40. This facilitates efficient giving of the force sensation to the user.

(1-4) According to the above-described first embodiment, the control device 70 executes the first control depending on the temperature. Accordingly, the user can be suggested that the hair dryer 10 be separated from the hair before the temperature of the hair does not increase excessively.

### Second Embodiment

Hereinafter, a second embodiment in which the handle is applied to a facial care device is described with reference to the drawings. In the drawings, elements may be illustrated in enlarged scale to facilitate the understanding. The rates of the dimensions of the elements may be different from the actual rates or the rates in other drawings.

(About Overall Configuration)

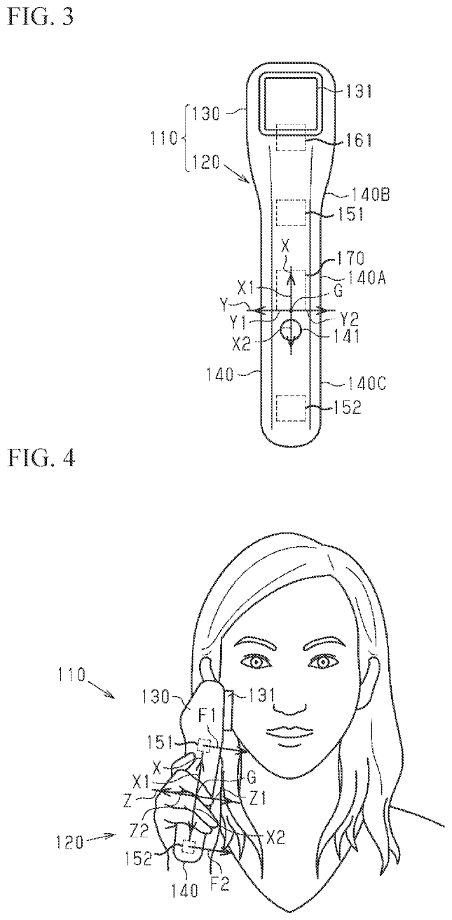

As illustrated in FIG. 3, a facial care device 110 includes a handle 120 and a head 130. The handle 120 includes a housing 140 that the user can hold with the fingers. The housing 140 as a whole has a circular column shape.

An axis that passes through a center of gravity G of the housing 140 and extends in a direction in which the housing 140 extends is defined as a first reference axis X. One of axes orthogonal to the first reference axis X is defined as a second reference axis Y. An axis orthogonal to both the first reference axis X and the second reference axis Y is defined as a third reference axis Z. One of directions along the first reference axis X is defined as a first positive direction X1, and a direction opposite to the first positive direction X1 out of the directions along the first reference axis X is defined as a first negative direction X2. One of directions along the second reference axis Y is defined as a second positive direction Y1, and a direction opposite to the second positive direction Y1 out of the directions along the second reference axis Y is defined as a second negative direction Y2. One of directions along the third reference axis Z is defined as a third positive direction Z1, and a direction opposite to the third positive direction Z1 out of the directions along the third reference axis Z is defined as a third negative direction Z2.

The dimension of the housing 140 in the direction along the first reference axis X is greater than the dimension of the housing 140 in the direction along the second reference axis Y. The dimension of the housing 140 in the direction along the first reference axis X is greater than the dimension of the housing 140 in the direction along the third reference axis Z. That is, the housing 140 has a shape elongated in the direction along the first reference axis X. A switch 141 to turn on/off the power of the facial care device 110 is provided in the housing 140.

The housing 140 is broadly divided into a grip portion 140A, a first end portion 140B, and a second end portion 140C. The grip portion 140A is a central portion of the housing 140 including the center of gravity G. More specifically, the grip portion 140A is a portion that can be positioned on the inside of the fingers when the user holds the housing 140 with the fingers. According to the present embodiment, the grip portion 140A is defined as a range of 5 cm in the first positive direction X1 and 5 cm in the first negative direction X2 from the center of gravity G as the center, that is, a range of 10 cm in total. The first end portion 140B is adjacent to an end of the grip portion 140A on a side in the first positive direction X1. The second end portion 140C is adjacent to an end of the grip portion 140A on a side in the first negative direction X2.

The head 130 is connected to an end of the housing 140 on the side in the first positive direction X1, that is, the first end portion 140B. The head 130 includes an output portion 131 for performing skin care. Although it is not illustrated, the output portion 131 includes a plurality of terminals. Weak voltages are applied across the terminals by the output portion 131. When the output portion 131 is pressed against the skin of the user onto which a lotion or the like has been rubbed, an ingredient of the lotion or the like is easily permeated into the skin.

The handle 120 includes a first vibrating body 151 and a second vibrating body 152. Each of the vibrating bodies has a similar configuration as that of the vibrating body according to the first embodiment. The first vibrating body 151 is disposed in the first end portion 140B of the housing 140 of the handle 120. The first vibrating body 151 is positioned on the first reference axis X. Furthermore, the first vibrating body 151 is positioned on the side in the first positive direction X1 as viewed from the center of gravity G of the housing 140.

The second vibrating body 152 is disposed in the second end portion 140C of the housing 140 of the handle 120. The second vibrating body 152 is positioned on the first reference axis X. Also, the second vibrating body 152 is positioned on the side in the first negative direction X2 as viewed from the center of gravity G of the housing 140. The distance between the center of gravity G of the housing 140 and the first vibrating body 151 is set to be equal to the distance between the center of gravity G of the housing 140 and the second vibrating body 152.

The facial care device 110 includes a pressure sensor 161. The pressure sensor 161 is positioned next to the output portion 131 of the head 130. The pressure sensor 161 detects, from the output portion 131, a pressure exerted in a direction extending perpendicular to an output surface of the output portion 131 from the outside of the output surface toward the inside of the output portion 131. That is, the pressure sensor 161 detects the fact that the output portion 131 is pressed against the skin of the user and detects the degree of strength of the pressing.

The facial care device 110 includes a control device 170. The control device 170 includes a CPU and a ROM to execute software processes. The control device 170 obtains a signal indicating the pressure from the pressure sensor 161. In particular, the control device 170 controls operation of the first vibrating body 151 and operation of the second vibrating body 152.

The control device 170 can generate a first force sensation from the first vibrating body 151 in the first direction F1 by controlling a vibration pattern of the first vibrating body 151. The control device 170 can generate a second force sensation from the second vibrating body 152 in the second direction F2 by controlling a vibration pattern of the second vibrating body 152.

The control device 170 can execute a first control that sets the first direction F1 of the first force sensation and the second direction F2 of the second force sensation in a specific direction. When the first control is executed, the first direction F1 and the second direction F2 are set in the same direction. Furthermore, when the first control is executed, a virtual line directed from the first vibrating body 151 in the first direction F1 and a virtual line directed from the second vibrating body 152 in the second direction F2 are not positioned on the same line.

The control device 170 executes the first control depending on the pressure obtained from the pressure sensor 161. Specifically, when the pressure obtained from the pressure sensor 161 reduces, from a state in which the pressure obtained from the pressure sensor 161 exceeds a predetermined lower limit pressure, to a pressure lower than or equal to the lower limit pressure, the control device 170 executes the first control with both the first direction F1 and the second direction F2 set to the third positive direction Z1. The lower limit pressure is predetermined by testing or the like as a lower limit value of the pressure adequate to giving output from the output portion 131 to the skin.

Also, when the pressure obtained from the pressure sensor 161 increases, from a state in which the pressure obtained from the pressure sensor 161 is lower than a predetermined upper limit pressure, to a pressure higher than or equal to the upper limit pressure, the control device 170 executes the first control with both the first direction F1 and the second direction F2 set to the third negative direction Z2. The upper limit pressure is predetermined by testing or the like as an upper limit value of the pressure adequate to giving output from the output portion 131 to the skin. Furthermore, the upper limit pressure is determined to be a higher value than the above-described lower limit pressure. After executing the first control, when the pressure obtained from the pressure sensor 161 falls within a range between a pressure that exceeds the lower limit pressure and a pressure lower than the upper limit pressure, the control device 170 ends the first control.

### About Action of Second Embodiment

It is assumed that, as illustrated in FIG. 4, the user uses the facial care device 110 to perform skin care for, for example, the cheek in the face. In this case, the user can presses the output portion 131 of the head 130 out of the facial care device 110 against the skin with an appropriate force. However, due to, for example, a movement of the arm, hand, or the neck of the user, the facial care device 110 may be operated in a direction in which the head 130 is separated from the skin. According to the above-described second embodiment, when the pressure detected by the pressure sensor 161 changes to a pressure lower than the lower limit pressure, the control device 170 executes the first control with both the first direction F1 and the second direction F2 set to the third positive direction Z1.

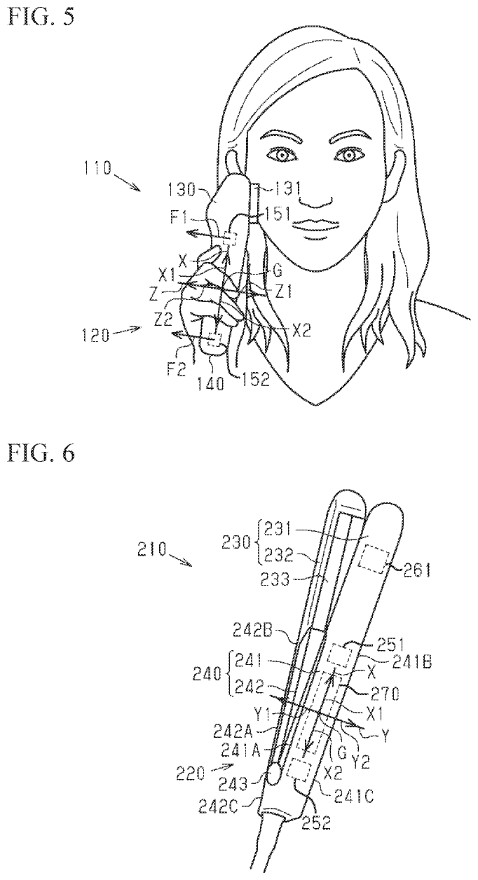

In contrast, as illustrated in FIG. 5, due to, for example, a movement of the arm, hand, or the neck of the user, the facial care device 110 may be operated so as to press the head 130 strongly against the skin. According to the above-described second embodiment, when the pressure detected by the pressure sensor 161 changes to a pressure higher than the upper limit value, the control device 170 executes the first control with both the first direction F1 and the second direction F2 set to the third negative direction Z2.

### About Effects of Second Embodiment

According to the above-described second embodiment, the following effects are produced in addition to effects similar to (1-1) to (1-3) according to the first embodiment.

(2-1) According to the above-described second embodiment, the control device 170 executes the first control depending on the pressure. Accordingly, depending on the pressure from the outside to the head 130, the user can be suggested that the facial care device 110 be moved farther from the skin or closer to the skin. That is, the user can be notified of a state in which the output portion 131 of the facial care device 110 is pressed against the skin at an appropriate pressure that is higher than the lower limit pressure and lower than the upper limit pressure.

### Third Embodiment

Hereinafter, a third embodiment in which the handle is applied to a hair iron is described with reference to the drawings. In the drawings, elements may be illustrated in enlarged scale to facilitate the understanding. The rates of the dimensions of the elements may be different from the actual rates or the rates in other drawings.

(About Overall Configuration)

As illustrated in FIG. 6, a hair iron 210 includes a handle 220 and a head 230. The handle 220 includes a housing 240 that the user can hold with the fingers. The housing 240 includes a first housing 241 and a second housing 242. The first housing 241 as a whole has a columnar shape. The second housing 242 as a whole has a columnar shape.

An axis that passes through a center of gravity G of the first housing 241 and extends in a direction in which the first housing 241 extends is defined as a first reference axis X. One of axes orthogonal to the first reference axis X is defined as a second reference axis Y. An axis orthogonal to both the first reference axis X and the second reference axis Y is defined as a third reference axis Z. One of directions along the first reference axis X is defined as a first positive direction X1, and a direction opposite to the first positive direction X1 out of the directions along the first reference axis X is defined as a first negative direction X2. One of directions along the second reference axis Y is defined as a second positive direction Y1, and a direction opposite to the second positive direction Y1 out of the directions along the second reference axis Y is defined as a second negative direction Y2. One of directions along the third reference axis Z is defined as a third positive direction Z1, and a direction opposite to the third positive direction Z1 out of the directions along the third reference axis Z is defined as a third negative direction Z2.

The dimension of the first housing 241 in the direction along the first reference axis X is greater than the dimension of the first housing 241 in the direction along the second reference axis Y. The dimension of the first housing 241 in the direction along the first reference axis X is greater than the dimension of the first housing 241 in the direction along the third reference axis Z. That is, the first housing 241 has a shape elongated in the direction along the first reference axis X. Similarly, the second housing 242 has a shape elongated in the direction along the first reference axis X.

The first housing 241 is broadly divided into a first grip portion 241A, a first end portion 241B, and a second end portion 241C. The first grip portion 241A is a central portion of the first housing 241 including the center of gravity G. More specifically, the first grip portion 241A is a portion that can be positioned on the inside of the fingers when the user holds the first housing 241 with the fingers. According to the present embodiment, the first grip portion 241A is defined as a range of 5 cm in the first positive direction X1 and 5 cm in the first negative direction X2 from the center of gravity G as the center, that is, a range of 10 cm in total. The first end portion 241B is adjacent to an end of the first grip portion 241A on a side in the first positive direction X1. The second end portion 241C is adjacent to an end of the first grip portion 241A on a side in the first negative direction X2.

The second housing 242 is adjacent to the first housing 241 and extends parallel to the first housing 241 on a side in the third negative direction Z2 as viewed from the first housing 241. An end of the first housing 241 on the first negative direction X2 is connected to an end of the second housing 242 in the first negative direction X2 by using a shaft body 243. The first housing 241 is rotatable relative to the second housing 242 around the shaft body 243 as a rotation axis. That is, the first housing 241 and the second housing 242 are able to be open or closed with the shaft body 243 acting as a fulcrum.

The second housing 242 is broadly divided into a second grip portion 242A, a first end portion 242B, and a second end portion 242C. The second grip portion 242A is a portion arranged beside the first grip portion 241A in the direction along the third reference axis Z in a state in which the first housing 241 and the second housing 242 are closed. The first end portion 242B is adjacent to an end on a side of the second grip portion 242A in the first positive direction X1. The second end portion 242C is adjacent to an end of the second grip portion 242A on a side in the first negative direction X2.

The head 230 includes a first clamping portion 231 and a second clamping portion 232. The first clamping portion 231 is connected to an end of the first housing 241 on a side in the first positive direction X1. The first clamping portion 231 as a whole has a rectangular shape elongated in a direction along the first reference axis X.

The second clamping portion 232 has a shape similar to that of the first clamping portion 231. The second clamping portion 232 includes a heater 233 for warming the hair. The second clamping portion 232 is connected to the second housing 242 so as to face the first clamping portion 231. When the first housing 241 and the second housing 242 are closed, the hair can be clamped between the first clamping portion 231 and the second clamping portion 232. The shape of the entirety of the hair can be adjusted by the heater 233 in the second clamping portion 232 in a state in which the hair is clamped between the first clamping portion 231 and the second clamping portion 232.

The handle 220 includes a first vibrating body 251 and a second vibrating body 252. Each of the vibrating bodies has a similar configuration as that of the vibrating body according to the first embodiment. The first vibrating body 251 is disposed in the first housing 241. The first vibrating body 251 is positioned on the first reference axis X. The first vibrating body 251 is positioned on the side in the first positive direction X1 as viewed from the center of gravity G of the first housing 241.

The second vibrating body 252 is disposed in the first housing 241. The second vibrating body 252 is positioned on the first reference axis X. The second vibrating body 252 is positioned on the side in the first positive direction X1 as viewed from the center of gravity G of the first housing 241. The distance between the center of gravity G of the first housing 241 and the first vibrating body 251 is set to be equal to the distance between the center of gravity G of the first housing 241 and the second vibrating body 252.

The hair iron 210 includes a distance sensor 261. The distance sensor 261 is disposed in the first clamping portion 231. The distance sensor 261 is a laser-type distance sensor. The distance sensor 261 radiates laser light in the second negative direction Y2 as viewed from the distance sensor 261 and detects the distance from the object based on reflection light of the laser light.

The hair iron 210 includes a control device 270. The control device 270 includes a CPU and a ROM to execute software processes. The control device 270 obtains a signal indicating the distance from the distance sensor 261. In particular, the control device 270 controls operation of the first vibrating body 251 and operation of the second vibrating body 252.

The control device 270 can generate a first force sensation from the first vibrating body 251 in a first direction F1 by controlling a vibration pattern of the first vibrating body 251. The control device 270 can generate a second force sensation from the second vibrating body 252 in a second direction F2 by controlling a vibration pattern of the second vibrating body 252.

The control device 270 can execute a first control that sets the first direction F1 of the first force sensation and the second direction F2 of the second force sensation to a specific direction. When the first control is executed, the first direction F1 and the second direction F2 are set in the same direction. Furthermore, when the first control is executed, a virtual line directed from the first vibrating body 251 in the first direction F1 and a virtual line directed from the second vibrating body 252 in the second direction F2 are not positioned on the same line. Specifically, according to the present embodiment, the control device 270 executes the first control with both the first direction F1 and the second direction F2 set to the second positive direction Y1.

The control device 270 executes the first control depending on the distance obtained from the distance sensor 261. Specifically, the control device 270 determines whether the distance obtained from the distance sensor 261 is smaller than a predetermined specified distance. The control device 270 executes the first control when the distance obtained from the distance sensor 261 is smaller than the specified distance. In this case, the control device 270 executes the first control with both the first direction F1 and the second direction F2 set to the second positive direction Y1. In contrast, the control device 270 does not execute the first control when the distance obtained from the distance sensor 261 is greater than or equal to the specified distance. That is, the control device 270 ends the first control when the distance obtained from the distance sensor 261 becomes greater than or equal to the specified distance in a situation in which the first control is executed.

### About Action of Third Embodiment

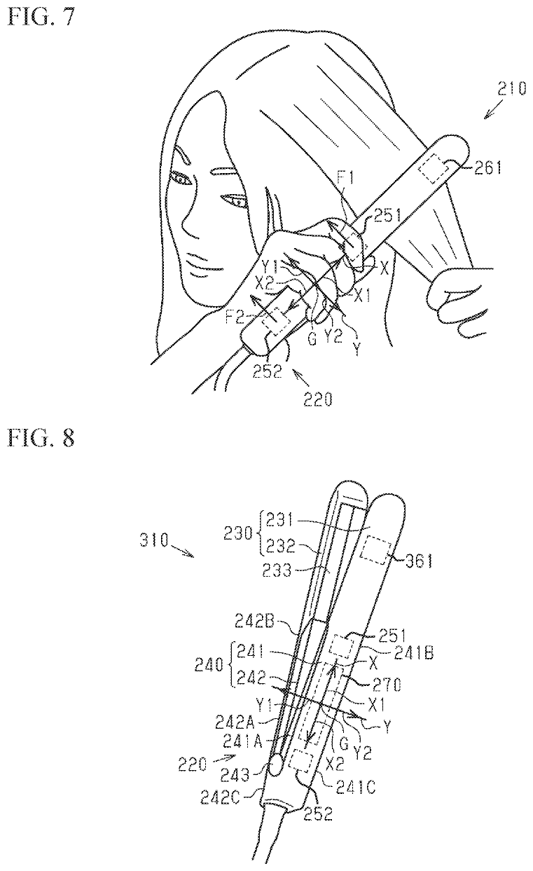

It is assumed that, as illustrated in FIG. 7, the user uses the hair iron 210 to tidy up his or her hair to straighten the hair. In this case, for example, the user forms part of the hair into a strand, and holds a tip end portion of the strand in his or her left hand. Next, the user holds the handle 220 in his or her right hand and causes the strand of hair to be clamped by the head 230. Then, the user moves the handle 220 straightly with the right hand from the root toward the tip end of the strand of hair. In this case, when the handle 220 is moved to the tip end portion, there is a possibility of the left hand being brought into contact with the hair iron 210.

According to the above-described third embodiment, the distance sensor 261 detects the distance from the left hand being an object existing in the second negative direction Y2. When the detected distance becomes smaller than the specified distance, the control device 270 executes the first control with both the first direction F1 and the second direction F2 set to the second positive direction Y1. Accordingly, the user can be given a sense with which the user feels as if translation in the second positive direction Y1 were performed.

### About Effects of Third Embodiment

According to the above-described third embodiment, the following effects are produced in addition to effects similar to (1-1) to (1-3) according to the first embodiment.

(3-1) According to the above-described third embodiment, the control device 270 executes the first control depending on the distance. Accordingly, depending on the distance, the user can be suggested that the hair iron 210 be moved in the first direction F1. As a result, the user can avoid the occurrences of a situation in which the hair iron 210 collides with his or her hand holding the tip end portion of a strand of hair.

### Fourth Embodiment

Hereinafter, a fourth embodiment in which the handle is applied to a hair iron is described with reference to the drawings. A sensor used in a hair iron 310 according to the fourth embodiment is different from that of the hair iron 210 according to the third embodiment. Hereinafter, differences from the third embodiment are mainly described, and description of similar configurations to those of the third embodiment is simplified or omitted. In the drawings, elements may be illustrated in enlarged scale to facilitate the understanding. The rates of the dimensions of the elements may be different from the actual rates or the rates in other drawings.

(About Overall Configuration)

As illustrated in FIG. 8, the hair iron 310 includes a temperature sensor 361 instead of the distance sensor 261 according to the third embodiment. The temperature sensor 361 detects the temperature between the first clamping portion 231 and the second clamping portion 232.

The control device 270 obtains a signal indicating the temperature from the temperature sensor 361. The control device 270 executes the first control depending on the temperature obtained from the temperature sensor 361. Specifically, according to the present embodiment, the control device 270 executes the first control with the first direction F1 and the second direction F2 set to the second negative direction Y2.

Specifically, the control device 270 determines whether the temperature obtained from the temperature sensor 361 is higher than a predetermined specified temperature. The specified temperature is predetermined by testing or the like as a temperature at which the hair is excessively heated. The control device 270 executes the first control when the temperature obtained from the temperature sensor 361 is higher than the specified temperature. In this case, the control device 270 executes the first control with both the first direction F1 and the second direction F2 set to the second negative direction Y2. In contrast, the control device 270 does not execute the first control when the temperature obtained from the temperature sensor 361 is lower than or equal to the specified temperature. That is, the control device 270 ends the first control when the temperature obtained from the temperature sensor 361 becomes lower than the specified temperature in a situation in which the first control is executed.

### About Action of Fourth Embodiment

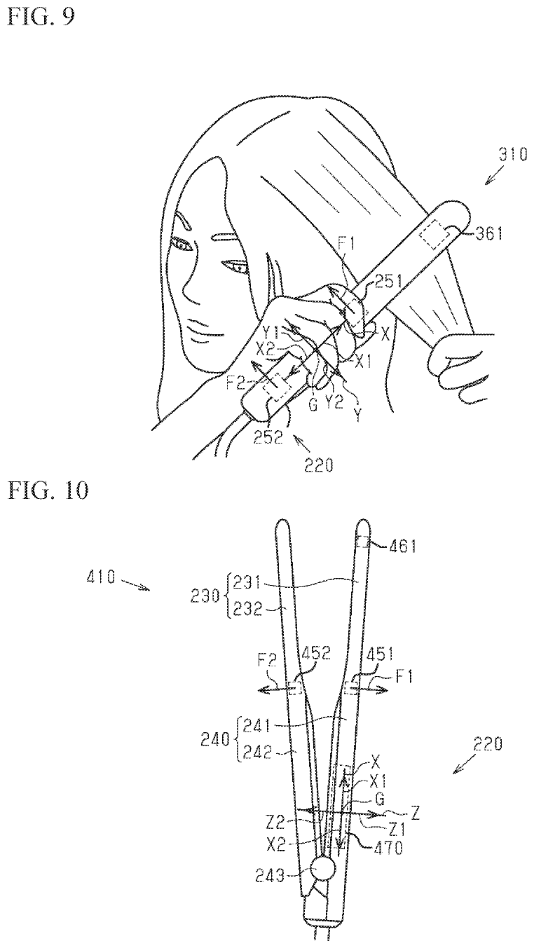

It is assumed that, as illustrated in FIG. 9, the user uses the hair iron 310 to tidy up his or her hair to straighten the hair. In this case, for example, the user forms part of the hair into a strand, and holds a tip end portion of the strand in his or her left hand. Next, the user holds the handle 220 in his or her right hand and causes the strand of hair to be clamped by the head 230. Then, the user moves the handle 220 straightly with the right hand from the root toward the tip end of the strand of hair. In this case, when the speed at which the user moves the handle 220 is excessively low, there is a possibility of excessive heating of the hair clamped by the head 230.

According to the above-described fourth embodiment, the temperature sensor 361 detects the temperature between the first clamping portion 231 and the second clamping portion 232. When the detected temperature becomes higher than the specified temperature, the control device 270 executes the first control with both the first direction F1 and the second direction F2 set to the second positive direction Y1. Accordingly, the user can be given a sense with which the user feels as if translation in the second positive direction Y1 were performed.

### About Effects of Fourth Embodiment

According to the above-described fourth embodiment, the following effects are produced in addition to effects similar to (1-1) to (1-3) according to the first embodiment.

(4-1) According to the above-described fourth embodiment, the control device 270 executes the first control depending on the temperature between the first clamping portion 231 and the second clamping portion 232. Accordingly, depending on the temperature, the user can be suggested that the hair iron 310 be moved in the first direction F1. As a result, the user can avoid excessive heating of the hair clamped by the head 230.

### Fifth Embodiment

In the hair iron 210 according to the above-described third embodiment, the first housing 241 and the second housing 242 are able to be open or closed with the shaft body 243 acting as a fulcrum. That is, from the viewpoint of opening/closing operation of the first housing 241 and the second housing 242, the first housing 241 and the second housing 242 rotate relative to each other with the same position as the fulcrum instead of being translated. For the purpose of guiding such a rotational operation, it is optional that two vibrating bodies are disposed in each housing.

Hereinafter, the fifth embodiment is described with reference to the drawings based on the viewpoint as described above. Arrangement of the vibrating bodies and control of the vibrating bodies in a hair iron 410 according to the fifth embodiment are different from those of the hair iron 310 according to the fourth embodiment. Hereinafter, differences from the fourth embodiment are mainly described, and description of similar configurations to those of the fourth embodiment is simplified or omitted. In the drawings, elements may be illustrated in enlarged scale to facilitate the understanding. The rates of the dimensions of the elements may be different from the actual rates or the rates in other drawings.

(About Overall Configuration)

As illustrated in FIG. 10, the handle 220 of the hair iron 410 includes a first vibrating body 451 and a second vibrating body 452. Each of the vibrating bodies has a similar configuration as that of the vibrating body according to the first embodiment.

The first vibrating body 451 is disposed in the first housing 241. The first vibrating body 451 is positioned on the first reference axis X. The first vibrating body 451 is positioned on the side in the first positive direction X1 as viewed from the center of gravity G of the first housing 241.

The second vibrating body 452 is disposed in the second housing 242. The second vibrating body 452 is positioned in the third negative direction Z2 as viewed from the first vibrating body 451 in a state in which the first clamping portion 231 and the second clamping portion 232 are closed.

The hair iron 410 includes a temperature sensor 461. The temperature sensor 461 detects the temperature between the first clamping portion 231 and the second clamping portion 232. The temperature sensor 461 is the same as the temperature sensor 361 according to the fourth embodiment.

The hair iron 410 includes a control device 470. The control device 470 includes a CPU and a ROM to execute software processes. The control device 470 obtains a signal indicating the temperature from the temperature sensor 461. In particular, the control device 470 controls operation of the first vibrating body 451 and operation of the second vibrating body 452.

The control device 470 can generate a first force sensation from the first vibrating body 451 in a first direction F1 by controlling a vibration pattern of the first vibrating body 451. The control device 470 can generate a second force sensation from the second vibrating body 452 in a second direction F2 by controlling a vibration pattern of the second vibrating body 452.

The control device 470 sets the first direction F1 of the first force sensation and the second direction F2 of the second force sensation to specific directions by controlling the vibration pattern of the first vibrating body 451 and the vibration pattern of the second vibrating body 452. The control device 470 determines whether the temperature obtained from the temperature sensor 461 is higher than a predetermined specified temperature. The specified temperature is predetermined by testing or the like as a temperature at which the hair is excessively heated. When the temperature obtained from the temperature sensor 461 is higher than the specified temperature, the control device 470 executes control of the vibration pattern of the first vibrating body 451 and the vibration pattern of the second vibrating body 452.

When the first control is executed, the first direction F1 and the second direction F2 are set in mutually opposite directions. Furthermore, when the first control is executed, a virtual line directed from the first vibrating body 451 in the first direction F1 and a virtual line directed from the second vibrating body 452 in the second direction F2 are positioned on the same line in a state in which the first housing 241 and the second housing 242 are closed. Specifically, according to the present embodiment, the control device 470 executes the first control with the first direction F1 set to the third positive direction Z1 and the second direction F2 set to the third negative direction Z2.

In this case, when the control device 470 starts the control, the first direction F1 and the second direction F2 are set in mutually opposite directions. That is, force sensations are given in such directions that the first clamping portion 231 and the second clamping portion 232 separate from each other. When the temperature obtained from the temperature sensor 461 is lower than or equal to the specified temperature, the control device 470 does not execute the above-described control. That is, the control device 470 ends the first control when the temperature obtained from the temperature sensor 461 becomes lower than the specified temperature in a situation in which the first control is executed.

### About Action of Fifth Embodiment

It is assumed that the user uses the hair iron 410 and clamps his or her hair at the head 230. In this case, when the same portion of the hair is clamped for a long time, there is a possibility of excessive heating of the hair.

According to the above-described fifth embodiment, the temperature sensor 461 detects the temperature between the first clamping portion 231 and the second clamping portion 232. When the detected temperature becomes higher than the specified temperature, the control device 470 generates the first force sensation and the second force sensation by controlling the first vibrating body 451 and the second vibrating body 452. At this time, since the first direction F1 of the first force sensation and the second direction F2 of the second force sensation are the mutually opposite directions, force sensations are given in such directions that the first clamping portion 231 and the second clamping portion 232 separate from each other. This can give the user a sensation of opening of the handle 220 so that the first clamping portion 231 and the second clamping portion 232 are separated from each other.

### About Effects of Fifth Embodiment

(5-1) According to the above-described fifth embodiment, when the temperature between the first clamping portion 231 and the second clamping portion 232 is higher than the specified temperature, a force sensation for separating the first clamping portion 231 and the second clamping portion 232 from each other can be generated. Thus, the user can be notified of a situation in which the first clamping portion 231 and the second clamping portion 232 should not be in closed state.

### Other Embodiments

Each of the above-described embodiments can be modified and carried out as follows. Each of the above-described embodiments and the following modifications can be carried out by being combined with each other to such a degree that no technical inconsistency occurs.
In each of the embodiments, the cylindrical shape may be changed as appropriate. For example, in the first embodiment, the shape of the housing 40 may be a cubic shape or a spherical shape. In this regard, the dimension of the housing in the direction along the first reference axis X may be the same as or smaller than the dimension of the housing 40 in the direction along the second reference axis Y.
In the first embodiment, the grip portion 40A of the housing 40 may be a central portion of the housing 40 when the housing 40 is trisected in a direction along the first reference axis X. In this case, the first end portion 40B is a portion including an end on the side in the first positive direction X1 out of three portions resulting from the trisection, and the second end portion 40C is a portion including an end on the side in the first negative direction X2 out of three portions resulting from the trisection. This is similarly applied to the other embodiments.
In each of the embodiments, the configuration of the vibrating body is not limited to the above-described configuration. For example, the vibrating body may utilize vibration generated by a motor or include a piezoelectric element.

For example, in the first embodiment, it is sufficient that the first vibrating body 51 be able to generate the first force sensation in the first direction F1. Accordingly, the first vibrating body 51 is not necessarily configured to generate the first force sensation in a plurality of directions. That is, for example, the first vibrating body 51 may be configured to be able to generate the first force sensation only in the second negative direction Y2.
In each of the embodiments, arrangement of the vibrating bodies may be changed as appropriate. For example, in the first embodiment, the distance between the center of gravity G of the housing 40 and the first vibrating body 51 and the distance between the center of gravity G of the housing 40 and the second vibrating body 52 may be different. Furthermore, for example, in the first embodiment, the first vibrating body 51 and the second vibrating body 52 may be disposed at positions offset from the first reference axis X.
In the first embodiment, the first direction F1 or the second direction F2 is not necessarily set as describe above. The first direction F1 and the second direction F2 can be set in directions to be desirably guided depending on a situation of use of the hair dryer 10.
In the first embodiment, it is sufficient that the first control be performed depending on the temperature. For example, a target temperature at which the hair is to be heated may be set in advance, and, when the temperature obtained from the temperature sensor 61 is lower than the target temperature, the first control may be performed with the first direction F1 set to the second positive direction Y1.
In the second embodiment, the control device 170 may perform the first control only in the case where the pressure changes so as to be smaller than the lower limit pressure, or only in the case where the pressure changes so as to exceeds the upper limit pressure.
In the second embodiment, the output portion 131 of the head 130 may have another function for performing skin care. For example, the output portion 131 may radiate light or apply vibration to the skin.
In the third to fifth embodiments, the heater 233 may be disposed in the first clamping portion 231 instead of the second clamping portion 232. Furthermore, the heater 233 may be disposed in each of the first clamping portion 231 and the second clamping portion 232.
In the third embodiment, the hair iron 210 may include, instead of the distance sensor 261, an open/close sensor that detects an open/close state of the first clamping portion 231 and the second clamping portion 232. In this case, the control device 270 may execute, instead of executing the first control depending on the distance, the first control after a predetermined specified period of time has elapsed from the time when the open/close sensor detected that the open/close state of the first clamping portion 231 and the second clamping portion 232 is in the closed state. The open/close sensor is, for example, a magnetic sensor, and it is sufficient that the magnetic sensor be disposed in one of the first clamping portion 231 and the second clamping portion 232. A magnet can be disposed in the other of the first clamping portion 231 and the second clamping portion 232. In this case, the magnetic sensor detects a magnetic force of the magnet when the first clamping portion 231 and the second clamping portion 232 are closed, and accordingly, it can be detected that the open/close state of the first clamping portion 231 and the second clamping portion 232 is in the closed state. The open/close sensor is not limited to the magnetic sensor. For example, the open/close state of the first clamping portion 231 and the second clamping portion 232 may be detected based on the rotational position of the shaft body 243. The specified period of time can be predetermined by testing or the like as, for example, a period of time taken to warm up with the heater. In this case, for example, when a portion near the root of a strand of the hair is clamped by the first clamping portion 231 and the second clamping portion 232, the user can be notified, after a specified period of time has elapsed, that the movement is desirably started.
In each of the above-described embodiments, the handle may be applied to other products operated in a state in which the user holds the handle with the fingers. For example, the handle may be applied to home haircut tools such as hair clippers. In particular, the handle can be utilized to a product in which a head connected to the handle is brought into direct contact with the body of the user or a product in which a head connected to the handle performs output toward the body of the user.
The handle can be used as a single unit. For example, when exercise or rehabilitation is performed, the handle can be used as a handle that can suggest the user which rotational direction the user desirably move his or her arm.
The control device is not limited to a device that includes a CPU and a ROM to execute software processes. For example, the control device may include a dedicated hardware circuit (for example, an application-specific integrated circuit (ASIC) or the like) that processes, as hardware, at least a subset of processes processed by software according to the above-described embodiments. That is, it is sufficient that the control device have any one of configurations (a) to (c) described below. (a) Including a processing device that executes all the above-described processes in accordance with a program and a program storage device such as a ROM in which the program is stored. (b) Including a processing device that executes a subset of the above-described processes in accordance with a program, a program storage device, and a dedicated hardware circuit that executes the remaining processes. (c) Including a dedicated hardware circuit that executes all the above-described processes. Herein, a plurality of a software executing devices that include the processing device and the program storage device or a plurality of dedicated hardware circuits may be provided.
In each of the above-described embodiments, programs and data used for the control performed by the control device may be updated from the outside. For example, in the first embodiment, the control device 70 may include a storage device. when data for controlling the vibration pattern of the first vibrating body 51 is input from an external device to the control device 70, the storage device can store the new data.
When the configurations of the vibrating bodies are changed as in the above-described modifications, for example, the first vibrating body and the second vibrating body 52 may be accommodated in a single casing. That is, it is sufficient that the handle include a haptics unit that is disposed in the housing and includes the first vibrating body and the second vibrating body. It is sufficient that the haptics unit give a force sensation to the user holding the housing so that the user feels as if the housing were translated. The control device may include a plurality of devices. In this case, each of the devices controls a corresponding one of the vibrating bodies. That is, it is sufficient that the handle include a control unit that controls the above-described haptics unit. As has been described, it is sufficient that the handle include the housing, the haptics unit disposed in the housing, and the control unit. In addition, it is sufficient that the control unit be able to control the haptics unit so as to give the force sensation to the user holding the housing so that the user feels as if the housing were translated.
In the handle of each of the above-described present embodiments, in giving the force sensation to the user so that the user feels as if the handle were translated, in some cases, the virtual line directed from the first vibrating body in the first direction F1 and the virtual line directed from the second vibrating body in the second direction F2 may be positioned on the same line. For example, in the first embodiment, both the first direction F1 and the second direction F2 may be set to the first positive direction X1 or the first negative direction X2. For example, when both the first vibrating body and the second vibrating body exist within a range that can be held by the user with the fingers, even in the case where the first direction F1 and the second direction F2 are positioned on the same line, giving of the force sensation that causes the user to feel as if the handle were rotated can be suppressed. Herein, the range that can be held by the user with the fingers is, for example, a range of a virtual sphere of 20 cm around the center of gravity G as the center.
In the hair iron 210 according to the above-described third embodiment, in order to give the user a sensation that causes the user to feel as if the hair iron 210 moved in the first direction F1, the first vibrating body 251 or the second vibrating body 252 is not necessarily disposed in the handle 220. For example, the first vibrating body 251 and the second vibrating body 252 may be disposed in the first clamping portion 231.
In the hair iron 310 according to the above-described fourth embodiment, in order to give the user a sensation that causes the user to feel as if the hair iron 310 moved in the first direction F1, the first vibrating body 251 or the second vibrating body 252 is not necessarily disposed in the handle 220. For example, the first vibrating body 251 and the second vibrating body 252 may be disposed in the first clamping portion 231.
In the hair iron 410 according to the above-described fifth embodiment, in order to give the user a force sensation that causes the user to feel as if the first clamping portion 231 and the second clamping portion 232 were separated from each other, the first vibrating body 451 is not necessarily disposed in the first housing 241. Similarly, the second vibrating body 452 is not necessarily disposed in the second housing 242. For example, the first vibrating body 451 may be disposed in the first clamping portion 231, and the second vibrating body 452 may be disposed in the second clamping portion 232.

A technical concept that can be grasped from the above-described embodiments and modifications is added below.

### APPENDIX 1

A handle that includes
a housing that a user is able to hold with his or her fingers,
a first vibrating body disposed in the housing,
a second vibrating body disposed in the housing, and
a control device able to generate a first force sensation in a first direction by controlling a vibration pattern of the first vibrating body and able to generate a second force sensation in a second direction by controlling a vibration pattern of the second vibrating body.

The control device is able to control the vibration pattern of the first vibrating body and the vibration pattern of the second vibrating body so as to set the first direction and the second direction are the same.

### APPENDIX 2

A hair iron that includes
a first housing including a first vibrating body,
a second housing including a second vibrating body,
a first clamping portion that is connected to the first housing and that is for clamping hair,
a second clamping portion that is connected to the second housing and that faces the first clamping portion for clamping the hair,
a shaft body that connects the first housing and the second housing to each other so as to allow the first housing and the second housing to be rotated,
a control device able to generate a first force sensation in a first direction by controlling a vibration pattern of the first vibrating body and able to generate a second force sensation in a second direction by controlling a vibration pattern of the second vibrating body, and
a temperature sensor configured to detect a temperature between the first clamping portion and the second clamping portion.

At least one of the first clamping portion and the second clamping portion includes a heater for warming the hair.

The control device is able to control the vibration pattern of the first vibrating body and the vibration pattern of the second vibrating body so as to set the first direction and the second direction in opposite directions in which the first clamping portion and the second clamping portion are separated from each other.

The control device starts the control of the first vibrating body and the second vibrating body when the temperature is higher than a predetermined specified temperature.

### APPENDIX 3

A hair iron includes
a first vibrating body,
a second vibrating body,
a handle including a housing that a user is able to hold with his or her fingers,
a head that is connected to the handle and that includes a first clamping portion and a second clamping portion for clamping hair,
a control device able to generate a first force sensation in a first direction by controlling a vibration pattern of the first vibrating body and able to generate a second force sensation in a second direction by controlling a vibration pattern of the second vibrating body, and
a distance sensor configured to detect a distance from an object positioned in an opposite direction to the first direction as viewed from the head.

At least one of the first clamping portion and the second clamping portion includes a heater for warming the hair.

The control device is able to execute a first control that controls the vibration pattern of the first vibrating body and the vibration pattern of the second vibrating body so as to set the first direction and the second direction to be identical to each other, and so as not to allow a virtual line directed from the first vibrating body in the first direction and a virtual line directed from the second vibrating body in the second direction to be positioned on a single line.

The control device executes the first control depending on the distance.

<Appendix 4>

A hair iron includes
a first vibrating body,
a second vibrating body,
a handle including a housing that a user is able to hold with his or her fingers,
a head that is connected to the handle and that includes a first clamping portion and a second clamping portion for clamping hair,
a control device able to generate a first force sensation in a first direction by controlling a vibration pattern of the first vibrating body and able to generate a second force sensation in a second direction by controlling a vibration pattern of the second vibrating body, and
a temperature sensor configured to detect a temperature between the first clamping portion and the second clamping portion.

At least one of the first clamping portion and the second clamping portion includes a heater for warming the hair.

The control device is able to execute a first control that controls the vibration pattern of the first vibrating body and the vibration pattern of the second vibrating body so as to set the first direction and the second direction to be identical to each other, and so as not to allow a virtual line directed from the first vibrating body in the first direction and a virtual line directed from the second vibrating body in the second direction to be positioned on a single line.

The control device executes the first control depending on the temperature.

### REFERENCE SIGNS LIST

10 hair dryer
20, 120, 220, 420 handle
30, 130, 230, 430 head
40, 140, 240 housing
51, 151, 251, 451 first vibrating body
52, 152, 252, 452 second vibrating body
61, 361, 461 temperature sensor
70, 170, 270, 470 control device
110 facial care device
131 output portion
161 pressure sensor
210 hair iron
231 first clamping portion
232 second clamping portion
241 first housing
242 second housing
243 shaft body
261 distance sensor
310, 410 hair iron

1. A handle comprising:
a housing that is holdable with fingers of a user;
a first vibrating body in the housing;
a second vibrating body in the housing; and
a controller configured to generate a first force sensation in a first direction by controlling a vibration pattern of the first vibrating body, and to generate a second force sensation in a second direction by controlling a vibration pattern of the second vibrating body,
wherein the controller is configured to control the vibration pattern of the first vibrating body and the vibration pattern of the second vibrating body such that virtual lines extending from the first vibrating body in the first direction and from the second vibrating body in the second direction are parallel with each other and do not overlap.

2. The handle according to claim 1,
wherein an axis passing through a center of gravity of the housing is a first reference axis and an axis orthogonal to the first reference axis is a second reference axis,
wherein a dimension of the housing along the first reference axis is greater than a dimension of the housing along the second reference axis,
wherein the first vibrating body and the second vibrating body are on opposite sides of the second reference axis and are along the first reference axis as viewed from the center of gravity, and
wherein the first direction and the second direction are orthogonal to the first reference axis.

3. The handle according to claim 2,
wherein the housing comprises a grip portion including the center of gravity, a first end portion adjacent to a first end of the grip portion, and a second end portion adjacent to a second end of the grip portion,
wherein the first vibrating body is in the first end portion, and
wherein the second vibrating body is in the second end portion.

4. A hair dryer comprising:
the handle according to claim 1;
a head that is connected to the handle and that is configured to blow air; and
a temperature sensor configured to detect a temperature of an object at a destination of the blown air,
wherein the controller is configured to control the vibration patterns depending on the temperature.

5. A facial care device comprising:
the handle according to claim 1;
a head that is connected to the handle and that comprises an output portion configured to perform a skin care function; and
a pressure sensor configured to detect a pressure of the head,
wherein the controller is configured to control the vibration patterns depending on the pressure.

6. A hair iron comprising:
the handle according to claim 1;
a head that is connected to the handle and that comprises a first clamping portion and a second clamping portion configured to clamp hair; and
a distance sensor configured to detect a distance from an object positioned in an opposite direction to the first direction as viewed from the head,
wherein the first clamping portion or the second clamping portion comprises a heater configured to warm the hair, and
wherein the controller is configured to control the vibration patterns depending on the distance.

7. A hair iron comprising:
the handle according to claim 1;
a head that is connected to the handle and that comprises a first clamping portion and a second clamping portion configured to clamp hair; and
a temperature sensor configured to detect a temperature between the first clamping portion and the second clamping portion,
wherein the first clamping portion or the second clamping portion comprises a heater configured to warm the hair, and
wherein the controller is configured to control the vibration patterns depending on the temperature.

8. A hair iron comprising:
the handle according to claim 1;
a head that is connected to the handle and that comprises a first clamping portion and a second clamping portion configured to clamp hair; and
an open/close sensor configured to detect an open/close state of the first clamping portion and the second clamping portion,
wherein the first clamping portion or the second clamping portion comprises a heater configured to warm the hair, and
wherein the controller is configured to control the vibration patterns when a predetermined specified period of time has elapsed from a time when the open/close state became a closed state.

9. A handle comprising:
a housing that is holdable with fingers of a user;
a haptics unit that is in the housing and that comprises a first vibrating body and a second vibrating body; and
a controller configured to control the haptics unit so as to cause the haptics unit to give the user holding the housing a force sensation in which the user feels as if the housing were translated.
